(19) United States
(12) Patent Application Publication
(10) Pub. No.: US 2002/0099566 A1
(43) Pub. Date: Jul. 25, 2002

(54) Network service applying apparatus, network service applying method, strorage medium and computer data signal

(76) Inventor: Fumio Kobayashi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/052,711

(22) Filed: Jan. 18, 2002

(30) Foreign Application Priority Data
Jan. 24, 2001 (JP) 2001-016346

(51) Int. Cl. G06F 17/60

(52) U.S. Cl. 705/1

(57) ABSTRACT

When receiving a domain name from a terminal, a server determines whether or not the domain name has already been assigned. When the domain name has not been assigned yet, the server accepts card information from the terminal. When the server decides that a credit by the card information is allowable, the server accepts a request for a hosting service and generates and stores a log-in ID and a password when the request is made from the terminal. When a user who has undergone authentication using the log-in ID and the password requests a permission to provide a third party with a dial-up connection service, a dial-up ID and a password for the third party are generated and a settlement is made using the card information of the user indicated by the log-in ID.

### BACKGROUND OF THE INVENTION

1. Field of the Invention

The present invention relates to a network service applying apparatus and a network service applying method which assist acquisition of a domain name which designates a memory area in a network and provide a memory area (domain) associated with the domain name.

2. Description of the Related Art

For a person who does not have his or her own server to secure the person's unique domain (memory area) in the Internet, the person should apply to an organization that manages domain names to be used as information for designating memory areas (such as JPNIC (Japan Network Information Center) or InterNIC) for registration of a domain name first, and then registers the applied domain name if the domain name has not been registered yet. The person then should apply to a business entity who has a server for assignment (hosting) of a memory area which is associated with the registered domain name.

For a person who has been granted the hosting of a domain to give a plurality of third parties a right to receive a service for connection to the Internet (specifically, a service for dial-up connection to the Internet or a service for continuous connection or always-ON connection), generally the person who has been granted the hosting separately applies to the Internet service provider or the like.

However, separately executing procedures of applying for hosting and applying for receiving a network connection service are troublesome. There is therefore a demand for a method which allows a plurality of applications to be made in a series of procedures.

There has never been a service which automatically gives a user of a hosting service a right to provide a third party with a network connection service. This makes it necessary to take tiresome procedures of separately making applications for a plurality of services. It would therefore take time to actually start providing those services since the time filing the applications was started.

As hosting and a network connection service are both normally charged fees, it is troublesome to settle considerations of those services.

### SUMMARY OF THE INVENTION

Accordingly, it is an object of the invention to provide a network service applying apparatus and a network service applying method which allow procedures of applying for hosting and applying for receiving a network connection service to be continuously carried out.

It is another object of the invention to provide a network service applying apparatus and a network service applying method which facilitate settlement of considerations of services that a user receives.

To achieve the objects, according to one aspect of the invention, there is provided a network service applying apparatus comprising an accepting server and memory, wherein said accepting server:

inputs a domain name associated with a memory area accessible via a network;

inputs and stores credit information to be used for a user who is to be assigned with said memory area specified by said domain name to receive a credit;

sends out said input credit information and acquires examination result data indicating allowance or denial of a credit using said credit information sent out when receiving said examination result data;

determines whether or not a memory area to be associated with said input domain name is to be assigned to said user based on said acquired examination result data and, when having decided to assign said memory area to said user, inputs user information for specifying said user, and generates and outputs ID data for identifying said user;

stores said user information into said memory; and

when externally receiving said ID data and a notification indicating that a right to receive a network connection service is given to a third party, generates and outputs network connection ID data for identifying said right to be given to said third party by that user who is identified by said ID data, and a password associated with said network connection ID data.

The accepting server may further charge a user who is to receive a credit using said stored credit information with a consideration of assignment of said memory area to said user and a consideration of said network connection service a right for whose reception has been given to said third party by said user, by using said credit information.

The accepting server may further send out said input domain name as one to be newly used and acquires use status report data indicating whether or not said sent domain name has already been used when receiving said use status report data; and determine whether or not said input domain name as one to be newly used has already been used based on said acquired use status report data and stops inputting said credit information when having determined that said domain name has already been used.

The network service applying apparatus may further comprise an authentication server, wherein said authentication server:

encrypts said password generated by said accepting server and stores said password and said network connection ID data with which said password is associated in association with each other; and

when externally supplied with said network connection ID data and a password via a telephone line, determines whether or not said encrypted password associated with said network connection ID data substantially matches with said externally supplied password, and grants connection to said network via said telephone line to said third party identified by said network connection ID data when there is a match.

According to another aspect of the invention, there is provided a network service applying apparatus comprising:

a domain name input section which inputs a domain name associated with a memory area accessible via a network;

a credit information input section which inputs and stores credit information to be used for a user who is to be assigned with said memory area specified by said domain name input by said domain name input section to receive a credit;

a credit examination assisting section which sends out said credit information input by said credit information input section and acquires examination result data indicating allowance or denial of a credit using said credit information sent out when receiving said examination result data;

a user information input section which determines whether or not a memory area to be associated with said domain name input by said domain name input section is to be assigned to said user based on said examination result data acquired by said credit examination assisting section and, when having decided to assign said memory area to said user, inputs user information for specifying said user, and generates and outputs ID data for identifying said user; and

a network connection service granting section which, when externally receiving said ID data and a notification indicating that a right to receive a network connection service is given to a third party, generates and outputs network connection ID data for identifying said right to be given to said third party by that user who is identified by said ID data, and a password associated with said network connection ID data.

According to another aspect of the invention, there is provided a network service applying method which:

inputs a domain name associated with a memory area accessible via a network;

inputs and stores credit information to be used for a user who is to be assigned with said memory area specified by said input domain name to receive a credit;

sends out said input credit information and acquires examination result data indicating allowance or denial of a credit using said credit information sent out when receiving said examination result data;

determines whether or not a memory area to be associated with said input domain name is to be assigned to said user based on said acquired examination result data and, when having decided to assign said memory area to said user, inputs user information for specifying said user, and generates and outputs ID data for identifying said user; and

when externally receiving said ID data and a notification indicating that a right to receive a network connection service is given to a third party, generates and outputs network connection ID data for identifying said right to be given to said third party by that user who is identified by said ID data, and a password associated with said network connection ID data.

According to another aspect of the invention, there is provided a computer-readable storage medium having a computer-program recorded thereon, said computer-program allowing a computer to function of:

inputting a domain name associated with a memory area accessible via a network;

inputting and storing credit information to be used for a user who is to be assigned with said memory area specified by said domain name to receive a credit;

sending out said input credit information and acquires examination result data indicating allowance or denial of a credit using said credit information sent out when receiving said examination result data;

determining whether or not a memory area to be associated with said input domain name is to be assigned to said user based on said acquired examination result data and, when having decided to assign said memory area to said user, inputs user information for specifying said user, and generates and outputs ID data for identifying said user; and

when externally receiving said ID data and a notification indicating that a right to receive a network connection service is given to a third party, generates and outputs network connection ID data for identifying said right to be given to said third party by that user who is identified by said ID data, and a password associated with said network connection ID data.

According to another aspect of the invention, there is provided a computer data signal embedded in a carrier wave expressing a program for allowing a computer to function of:

inputting a domain name associated with a memory area accessible via a network;

inputting and storing credit information to be used for a user who is to be assigned with said memory area specified by said domain name to receive a credit;

sending out said input credit information and acquires examination result data indicating allowance or denial of a credit using said credit information sent out when receiving said examination result data;

determining whether or not a memory area to be associated with said input domain name is to be assigned to said user based on said acquired examination result data and, when having decided to assign said memory area to said user, inputs user information for specifying said user, and generates and outputs ID data for identifying said user; and

when externally receiving said ID data and a notification indicating that a right to receive a network connection service is given to a third party, generates and outputs network connection ID data for identifying said right to be given to said third party by that user who is identified by said ID data, and a password associated with said network connection ID data.

### BRIEF DESCRIPTION OF THE DRAWINGS

FIG. 1 is a block diagram illustrating the structure of a hosting service providing system according to one embodiment of the invention;

FIG. 2 is a flowchart illustrating procedures of applying a hosting service;

FIG. 3 is a flowchart illustrating a continuation of the procedures of applying a hosting service;

FIG. 4 is a flowchart illustrating procedures of applying a dial-up service or the like;

FIG. 5 is a flowchart illustrating a continuation of the procedures of applying a dial-up service or the like; and

FIG. 6 is a flowchart illustrating a continuation of the procedures of applying a dial-up service or the like.

### DETAILED DESCRIPTION OF THE PREFERRED EMBODIMENT

A description will now be given of a network service applying apparatus and a network service applying method according to one embodiment of the invention as adapted to a hosting service providing system, as one example, which assists acquisition or the like of a unique domain of a user in a network, such as the Internet, with reference to the accompanying drawings.

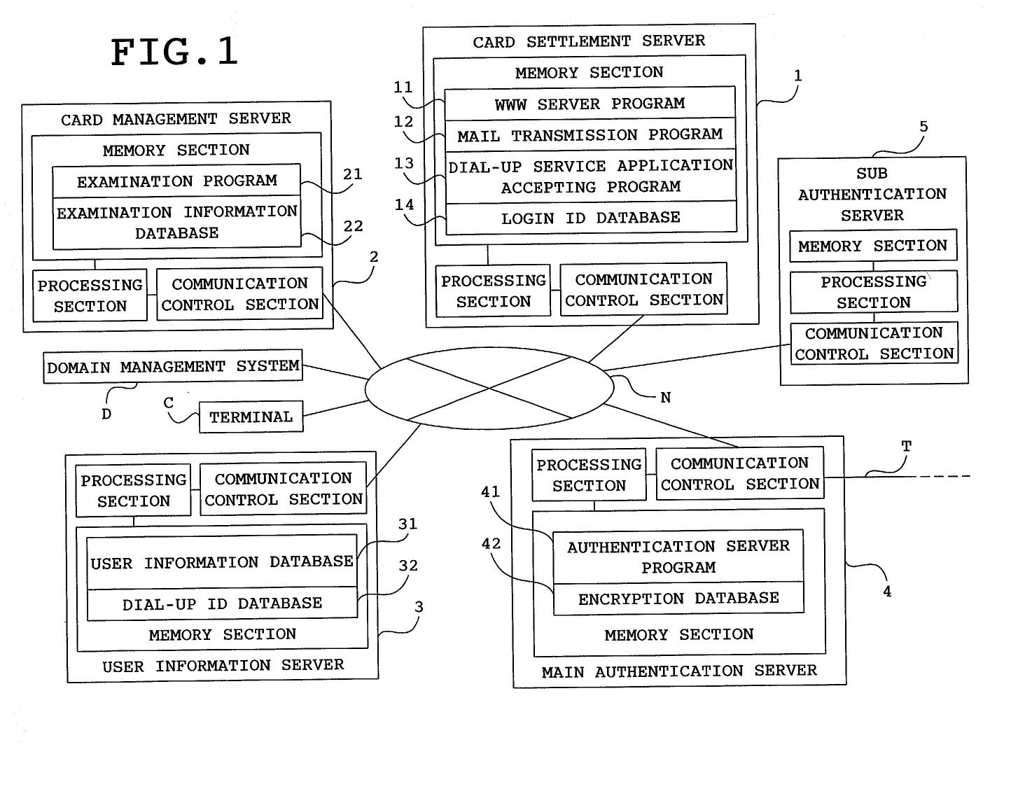

FIG. 1 illustrates the structure of a hosting service providing system according to the embodiment of the invention.

As illustrated, this hosting service providing system comprises a card settlement server 1, a card management server 2, a user information server 3, a main authentication server 4 and a sub authentication server 5.

The card settlement server 1, card management server 2, user information server 3, main authentication server 4 and sub authentication server 5 are connected to one another over a network N constructed by the Internet or the like.

An external terminal C is connected to the network N via an external dial-up server and a telephone line or the like.

Also connected to the network N is a domain management system D which stores assigned domain names. When a domain name is supplied over the network N, the domain management system D determines whether or not the supplied domain name has already been assigned to somebody and returns data indicating the determination result to the sender of the domain name over the network N.

Each of the card settlement server 1, card management server 2, user information server 3, main authentication server 4 and sub authentication server 5 is constructed by a server computer or the like and comprises a processing section which includes a CPU (Central Processing Unit) or the like, a communication control section which includes a DSU (Data Service Unit) and a terminal adaptor or the like and is connected to a control section, and a memory section which includes a hard disk unit and RAM (Random Access Memory) or the like and is connected to the control section. The processing section of each server performs processes to be discussed later by executing various kinds of programs to be discussed later which are stored in the memory section of that server. In case where the servers exchange data with one another, the processing section of each server sends and receives data via the communication control section of that server and the network N.

As shown in FIG. 1, the memory section of the card settlement server 1 stores a WWW (World Wide Web) server program 11, a mail transmission program 12, a dialup service application accepting program 13 and a log-in ID (IDentification) data base 14. The memory section of the card settlement server 1 also stores data representing a domain search Web page and a manager Web page which will be discussed later. In response to an access made by the processing section of the card settlement server 1, the memory section provides the processing section with those programs stored in the memory section, data stored in the log-in ID data base 14 and to be discussed later or data representing the manager Web page.

The WWW server program 11 is a program which allows the card settlement server 1 to execute the process of a WWW server.

The card settlement server 1 that executes the WWW server program 11 exchanges data with a terminal connected to the network N, such as the terminal C, in accordance with the HTTP (HyperText Transfer Protocol). Specifically, when receiving, for example, a URL (Uniform Resource Locator) indicating the logical position of data over the network N, the card settlement server 1 reads data at the logical position indicated by the URL in a memory area in the memory section of the server 1 or a memory area in a memory unit the server 1 can access. Then, the card settlement server 1 returns the read data to the sender of the URL (e.g., the terminal C).

The mail transmission program 12 is a program which allows the card settlement server 1 to send an electronic mail (hereinafter referred to as “e-mail”). That is, the card settlement server 1 that executes the mail transmission program 12 sends an e-mail to the network N according to a protocol, such as the SMTP (Simple Mail Transfer Protocol).

The dial-up service application accepting program 13 is a program which allows the card settlement server 1 to execute processes of steps S412 to S414 to be discussed later. The dial-up service application accepting program 13 is constructed by a CGI (Common Gate Interface) or the like which is executed under the control of the WWW server program 11.

The log-in ID data base 14 stores a log-in ID and log-in password, both assigned to a user of the hosting service providing system, in association with each other.

The card management server 2 is managed by, for example, a credit card issuer. The memory section of the card management server 2 stores an examination program 21 and an examination information data base 22 as shown in FIG. 1. In response to an access made by the processing section of the card management server 2, the memory section of the card management server 2 provides the processing section with the examination program 21 or data stored in the examination information data base 22.

The examination program 21 is a program which allows the card management server 2 to execute processes to be discussed later.

The examination information data base 22 stores the log-in ID examination information about the state of a settlement using a credit card owned by the user to whom the log-in ID is assigned, in association with each other.

The examination information includes, for example, the card number of a credit card, the period of validity of the credit card, the balance of the credit card and information representing the history of settlements using the credit card.

As shown in FIG. 1, the memory section of the user information server 3 stores a user information data base 31 and a dial-up ID data base 32. The memory section of the user information server 3 also stores an unillustrated program which allows the processing section of the user information server 3 to intervene accesses made to the user information data base 31 and the dial-up ID data base 32 by the card settlement server 1 and the main authentication server 4. In accordance with an access made by the card settlement server 1 or the main authentication server 4, the processing section of the user information server 3 receives or updates data stored in the user information data base 31 and the dial-up ID data base 32.

The user information data base 31 stores, for example, following data (1) to (5) in association with each other:

(1) the aforementioned log-in ID,

(2) a domain name a user indicated by the log-in ID (1) has,

(3) basic information about the user indicated by the log-in ID (1),

(4) card information about a credit card the user indicated by the log-in ID (1) uses for a settlement, and

(5) service contents information representing the contents of services usable by the user indicated by the log-in ID (1).

Of those data, the basic information (i.e., the data (3)) includes, for example, following data (a) to (c):

(a) organization information about a person who has a JP domain (a domain with a domain name which ends at “.jp”),

(b) organization information about a person who has a gr.jp domain (a domain with a domain name which ends at “.gr.jp”; one type of JP domains), and

(c) organization information about a person who has a gTLD (general Top Level Domain) domain (a domain with a domain name which ends at a dot followed by three alphabets, such as “.com”, “org” or “.net”).

Specifically, the data (a) is included in basic information associated with the data (1) that represents the domain name of a JP domain. The data (b) is included in basic information associated with the data (1) that represents the domain name of a gr.jp domain. The data (c) is included in basic information associated with the data (1) that represents the domain name of a gTLD domain.

Specifically, the data (a) or the organization information about a person who has a JP domain includes, for example, following items (a1) to (a18).

(a1) Transcription in Kanji or Chinese characters of the name of an organization or a user indicated by the data (1) with which the data (a) is associated.

(a2) Transcription of the name of the organization in Kana or Japanese syllabary alphabets.

(a3) Transcription of the name of the organization in English (or Roman alphabets).

(a4) The postal code number of the location of the organization.

(a5) Transcription of the address of the organization in Japanese.

(a6) Transcription of the address of the organization in English.

(a7) The type of the organization (which specifically indicates if the organization is, for example, a joint-stock corporation, a company Ltd., a limited partnership, an unlimited partnership or a corporation other than a company).

(a8) Transcription of the type of the organization in English.

(a9) The date when the organization was registered.

(a10) The registered address of the organization.

(a11) Transcription in Japanese of the name of an applicant who has applied for a hosting service that the organization receives.

(a12) Transcription of the name of the applicant in English.

(a13) The telephone number of the applicant.

(a14) The facsimile number of the applicant.

(a15) The e-mail address of the applicant.

(a16) Transcription of the name of the representative of the organization in Japanese.

(a17) Transcription of the name of this representative in English.

(a18) The title of this representative.

Specifically, the data (b) or the organization information about a person who has a gr.jp domain includes, for example, following items (b1) to (b7).

(b1) Transcription in Japanese of the name of a representative corporation which belongs to an organization or a user indicated by the data (1) with which the data (b) is associated.

(b2) Transcription in Japanese of the name of a deputy representative corporation which belongs to the organization.

(b3) Transcription of the name of the deputy representative corporation of the organization in Japanese.

(b4) Transcription of the name of this deputy representative corporation in English.

(b5) The title of the deputy representative corporation.

(b6) The date when the deputy representative corporation was registered.

(b7) The registered address of the deputy representative corporation.

The basic information that is associated with the data (1) representing the domain name of a gr.jp domain includes the data (a) in addition to the data (b).

Specifically, the data (c) or the organization information about a person who has a gTLD domain includes, for example, following items (c1) to (c12).

(c1) Transcription in Kanji or Chinese characters of the name of an organization or the name of an individual who is a user indicated by the data (1) with which the data (c) is associated.

(c2) Transcription of the name of the organization or the name of the individual in English.

(c3) The postal code number of the location of the organization or the individual.

(c4) Transcription in Japanese of the administrative division to which the address of the organization or the individual belongs.

(c5) Transcription in English of the administrative division to which the address of the organization or the individual belongs.

(c6) Transcription in Japanese of the city, ward or district to which the address of the organization or the individual belongs.

(c7) Transcription in English of the city, ward or district to which the address of the organization or the individual belongs.

(c8) Transcription of the number in the address of the organization or the individual in Japanese.

(c9) Transcription of the number in the address of the organization or the individual in English.

(c10) The telephone number of the organization or the individual.

(c11) The facsimile number of the organization or the individual.

(c12) The e-mail address of the organization or the individual.

The card data (i.e., the data (4)) includes, for example, following data (d1) to (d4).

(d1) The name of the issuer of a credit card which a user indicated by the data (1) with which the data (4) is associated uses for a settlement.

(d2) The number of the credit card.

(d3) The name of the owner of the credit card.

(d4) The period of validity of the credit card.

The service contents information (i.e., the data (5)) includes, for example, following data (e1) to (e17).

(e1) The memory capacity of a domain (memory area) assigned to a user indicated by the data (1) with which the data (5) is associated.

(e2) Data indicating whether or not the user is allowed to use a Web mail in the user's own domain.

(e3) A mail account assigned to the user.

(e4) Data indicating whether or not the user is allowed to issue a mail magazine.

(e5) Data indicating whether or not the user is allowed to transfer an e-mail.

(e6) Data indicating whether or not the user is allowed to use a mailing list.

(e7) Data indicating whether or not the user is allowed to automatically reply to an email.

(e8) Data indicating whether or not the user is allowed to use an access log analysis program in the user's own domain.

(e9) Data indicating whether or not the user is allowed to use a password approval program in the user's own domain.

(e10) Data indicating members whom the user has granted the use of the domain of the user.

(e11) A URL assigned to each of the members indicated by the data (e10).

(e12) Data indicating whether or not the user is allowed to use a bulletin board system (BBS) in the user's own domain.

(e13) Data indicating whether or not the user is allowed to use an access counter in the user's own domain.

(e14) Data indicating whether or not the user is allowed to use a CGI in the user's own domain.

(e15) Data indicating whether or not the user is allowed to use an SSL (Secure Socket Layer) in the user's own domain.

(e16) Data indicating whether or not the user is allowed to use a form mail in the user's own domain.

(e17) Data indicating whether or not the user is allowed to perform browser-based uploading of data in the user's own domain.

The dial-up ID data base 32 stores a dial-up ID assigned to a member whom the user has granted a right to make a dial-up connection to the main authentication server 4 and a dial-up password in association with each other.

As shown in FIG. 1, the memory section of the main authentication server 4 stores an authentication server program 41 and an encryption data base 42. In response to an access made by the processing section of the main authentication server 4, the memory section of the main authentication server 4 supplies the authentication server program 41 to the processing section. The communication control section of the main authentication server 4 is connected to an external telephone line T and is assigned with a specific telephone number. The communication control section of the main authentication server 4 makes communications with an external unit via the telephone line T under the control of the main authentication server 4.

The authentication server program 41 is a program that controls processes of steps S501 to S505 to be discussed later which are executed by the main authentication server 4 and allows the main authentication server 4 to execute the functions of a dial-up server.

Specifically, the main authentication server 4 that executes the functions of a dial-up server performs following processes (i) to (iii) in order.

(i) When an external terminal C which has a capability to make an IP (Internet Protocol) connection and is connected to the telephone line T calls the telephone number of the communication control section of the main authentication server 4 and starts communicating with the main authentication server 4 and then supplies the dialup ID and the dial-up password to the main authentication server 4, the main authentication server 4 first encrypts the supplied dial-up password by substantially the same scheme as the one that produces an encrypted password to be discussed later stored in the encryption data base 42, thereby generating an encrypted password for collation.

(ii) Next, the main authentication server 4 accesses the encryption data base 42 and specifies an encrypted password which is associated with the dial-up ID supplied to the main authentication server 4. Then, the main authentication server 4 determines whether or not the specified encrypted password matches with the encrypted password for collation that has been generated by the server 4.

(iii) When the main authentication server 4 has decided in the process (ii) that the two encrypted passwords do not match with each other, the main authentication server 4 terminates connection to the terminal that has supplied the dial-up ID and dial-up password. When the main authentication server 4 has decided that there is a match, on the other hand, the main authentication server 4 establishes a dial-up connection to the terminal and intervenes data transfer between the terminal and the network N.

The encryption data base 42 stores the dial-up ID and an encrypted password which is acquired by encrypting the dial-up password associated with the dial-up ID by a predetermined encryption scheme, in association with each other according to a process to be discussed later.

For the back-up purpose, the memory section of the sub authentication server 5 stores the encrypted password generated by the main authentication server 4 in association with the dial-up ID with which the dial-up password represented by the encrypted password is associated, in accordance with a process to be discussed later. The memory section of the sub authentication server 5 also stores an unillustrated program which allows the processing section of the sub authentication server 5 to intervene an access made by the main authentication server 4. In response to the access made by the main authentication server 4, the processing section of the sub authentication server 5 stores the encrypted password in a memory area in the memory section of the sub authentication server 5.

The terminal C, which is constructed by a personal computer or the like, includes a communication control unit which comprises a terminal adaptor or the like and is connected to the network N, an input unit having a keyboard and a mouse or the like, and a display unit having a liquid crystal display or the like. The terminal C is assigned with an IP address that identifies the terminal C. The IP address is preassigned or is assigned by an unillustrated server or the like which intervenes connection of the network N to the terminal C every time the terminal C is connected to the network N.

The terminal C executes the process of a WWW browser in accordance with the operation made by an operator. That is, when the operator instructs the initiation of the process of the WWW browser and inputs a URL, the terminal C accesses a unit (e.g., the card settlement server 1) which can access data located at the logical position indicated by the URL via the communication control unit of the terminal C and the network N. Then, the terminal C requests this unit of transmission of data located at the logical position indicated by the URL. The terminal C then receives data transmitted by the unit in response to that request and displays an image represented by the received data on the display screen of its own display unit. Note that the data has only to be described in, for example, the HTML (HyperText Markup Language).

In case where the image represented by the received data has an entry column to write a sequence of characters or radio buttons each for selecting one of plural choices for a specific item, the terminal C accepts the entry of a sequence of characters in the entry column or a choice selected by the radio button.

Specifically, when the operator selects the entry column displayed by the terminal C by operating the input unit of the terminal C and enters a sequence of characters in the entry column, the terminal C stores the input sequence of characters and displays the character sequence in the entry column. When the operator clicks a radio button displayed by the terminal C by manipulating the mouse of the terminal C, a choice indicated by the clicked radio button is selected and data indicating that selection of the other choices for the same item has been disabled is stored. The terminal C then redisplays the shape of the clicked radio button as a shape representing that the choice indicated by that radio button has been selected.

(Operation)

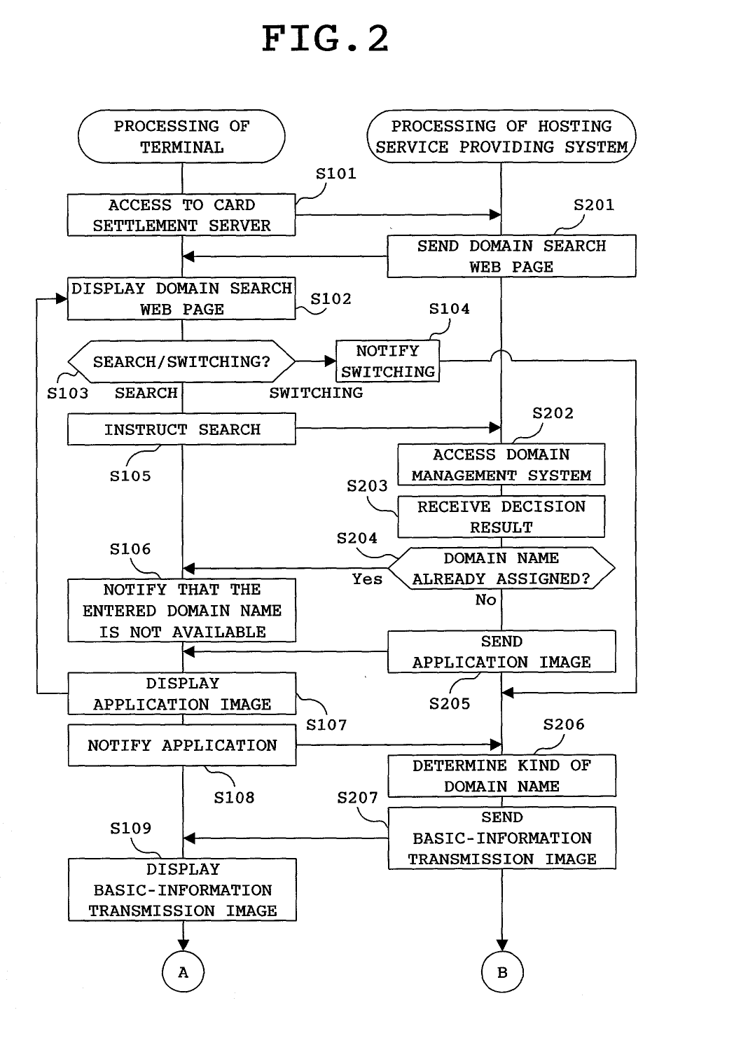

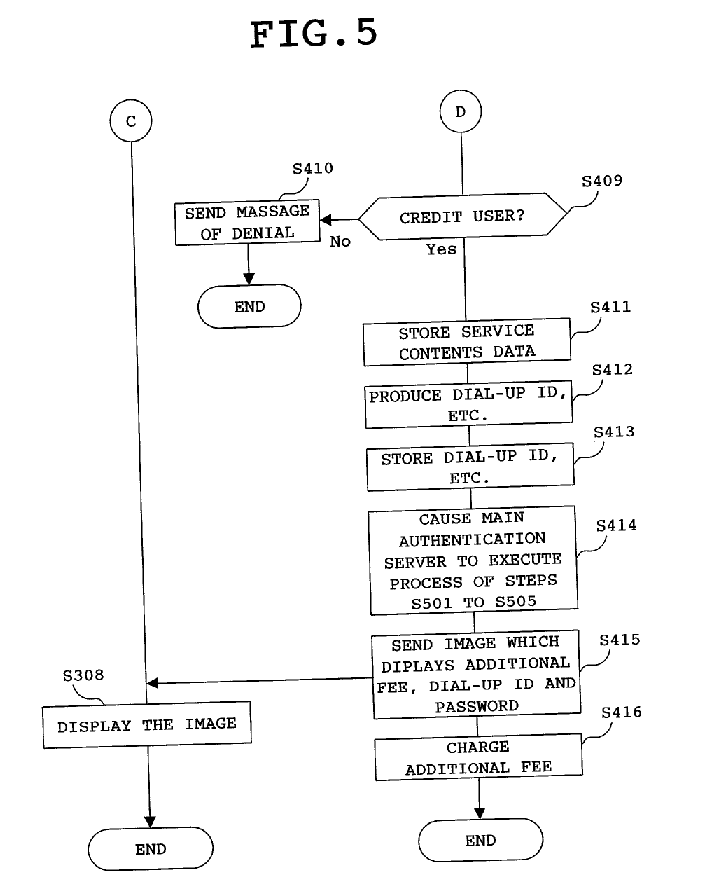

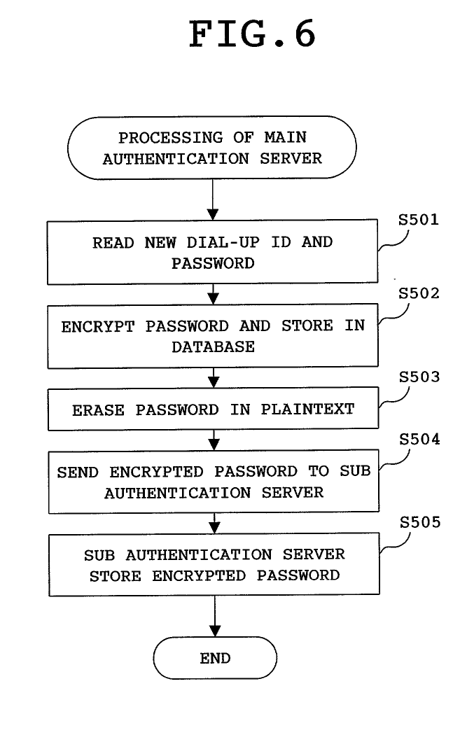

The operation of the hosting service providing system will now be described with reference to FIGS. 2 to 6.

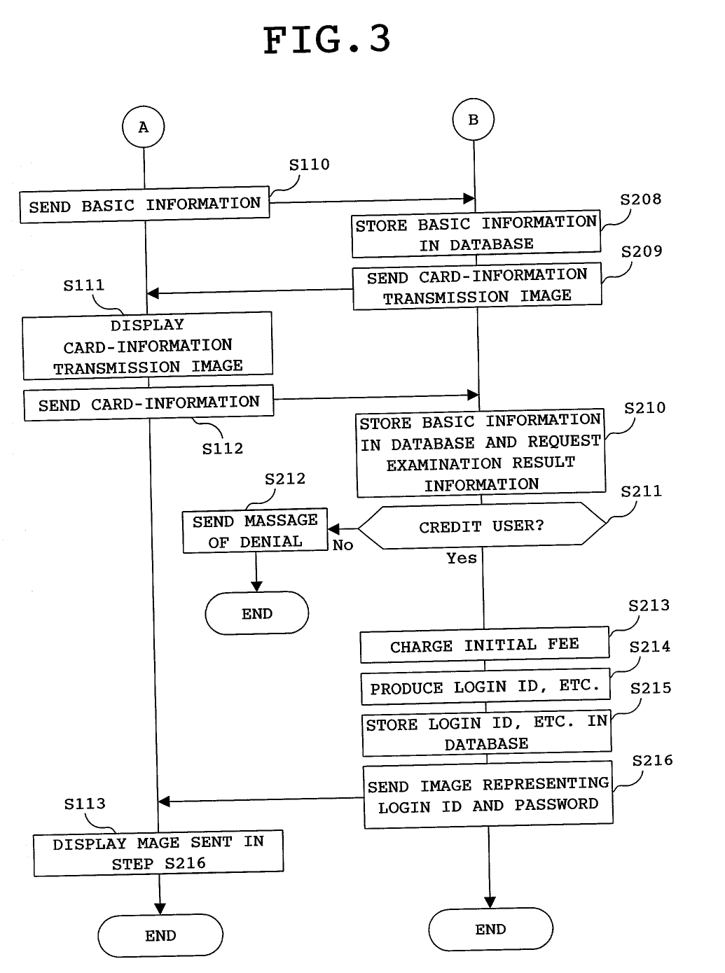

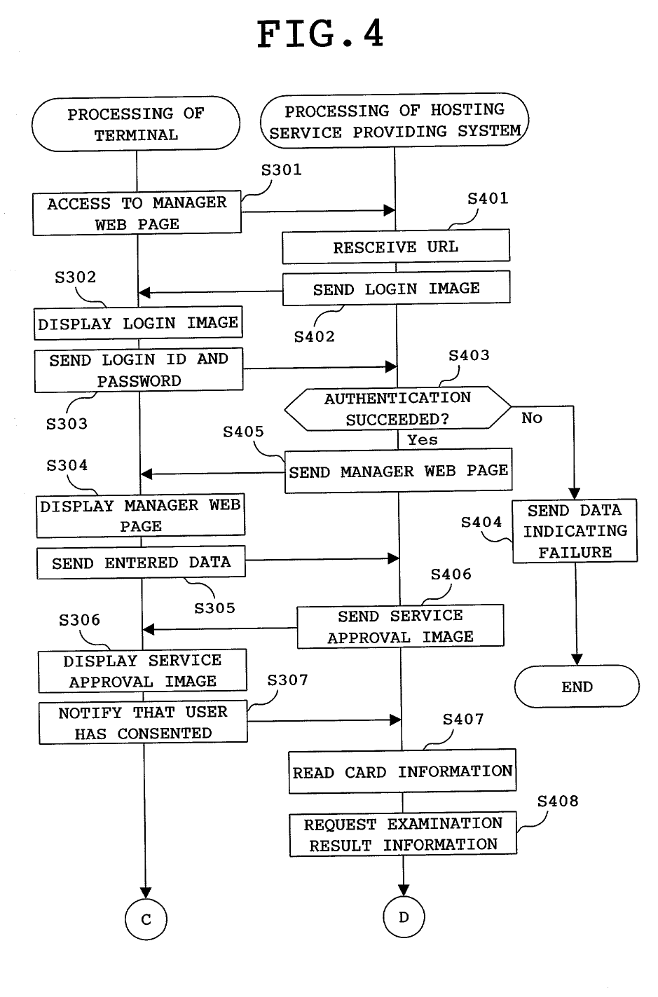

FIGS. 2 and 3 are flowcharts illustrating procedures of applying a hosting service. FIGS. 4 to 6 are flowcharts illustrating procedures of applying a dial-up service or the like.

(Hosting Service Applying Procedures)

A user who intends to apply for a hosting service manipulates the terminal C to execute the process of the VWW browser and inputs the URL of a domain search Web page, thereby instructing an access to the card settlement server 1 (step S101 in FIG. 2). In accordance with the instruction, the terminal C that executes the process of the WWW browser sends the URL of the domain search Web page and its own IP address to the network N and the card settlement server 1 receives the URL and the IP address of the terminal C sent to the network N.

When receiving the URL of the domain search Web page and the IP address of the terminal C, the card settlement server 1 reads the domain search Web page from its own memory section and sends the domain search Web page to the terminal C (step S201).

The domain search Web page has an entry column for a domain name the user wants (or a domain name the user already has), a search instruction button to instruct a search for a domain name and a switching instruction button to proceed with procedures of applying a hosting service with the domain name entered in the entry column as a vested one.

When receiving data sent by the card settlement server 1 in step S201, the terminal C displays a domain search image represented by the data (step S102).

When the operator of the terminal C enters a domain name in the entry column on the domain search image and clicks the search instruction button or the switching instruction button, the terminal C determines which one of the search instruction button and the switching instruction button has been clicked (step S103). When the terminal C determines that the switching instruction button has been clicked, the terminal C sends the card settlement server 1 the entered domain name and a notification notifying that a switching procedure will take place (step S104). When the terminal C determines that the search instruction button has been clicked, on the other hand, the terminal C sends the card settlement server 1 the entered domain name and a notification notifying an instruction of a search (step S105).

When receiving the domain name and the notification notifying that a switching procedure will take place both sent from the terminal C in step S104, the card settlement server 1 proceeds to step S205.

When receiving the domain name and the notification notifying an instruction of a search both sent from the terminal C in step S105, on the other hand, the card settlement server 1 accesses the domain management system D over the network N and provides the domain management system D with the domain name (step S202). Then, the domain management system D determines whether or not the provided domain name has already assigned to somebody and returns data indicating the decision result to the card settlement server 1 over the network N (step S203).

When receiving the data indicating the decision result sent from the domain management system D in step S203, the card settlement server 1 determines whether or not the data indicates that the domain name supplied from the terminal C has already been assigned to somebody. When the card settlement server 1 decides that the data indicates such an assignment of the domain name, the card settlement server 1 creates data representing an image including a message to the effect that the domain name entered by the operator of the terminal C is not available and sends the data to the terminal C (step S204). The terminal C receives the data sent in step S204, displays an image represented by the received data (step S106) and returns to step S102.

When the card settlement server 1 decides that the data indicates that the domain name supplied from the terminal C has not been assigned to anybody yet, on the other hand, the card settlement server 1 creates data representing an image (application image) which displays an agreement on provision of the service and prompts an approval, and then sends the data to the terminal C (step S205). As mentioned above, when receiving the domain name and the notification notifying that a switching procedure will take place both sent from the terminal C in step S104, the card settlement server 1 also creates data representing an application image and sends the data to the terminal C.

The application image includes a text of the agreement on the hosting service and an application button for consenting the agreement and notifying an application for the hosting service.

When receiving data sent by the card settlement server 1 in step S205, the terminal C displays the application image represented by the data (step S107). When the operator clicks the application button, the terminal C sends the card settlement server 1 a notification notifying that an application for the hosting service has been made (step S108).

When receiving the notification notifying that an application for the hosting service has been made, the card settlement server 1 determines whether or not the domain name supplied to the card settlement server 1 in step S105 or S104 is a JP domain or a gTLD domain (step S206). Then, the card settlement server 1 creates data which represents a basic-information transmission image matching with the decision result in step S206 and sends the data to the terminal C (step S207).

In case where the card settlement server 1 has decided in step S206 that the domain name is a JP domain, the basic-information transmission image includes entry columns to write the data (a) and data (b) and a transmission button to instruct transmission of the written data (a) and (b) to the card settlement server 1.

In case where the card settlement server 1 has decided in step S206 that the domain name is a gTLD domain, the basic-information transmission image includes an entry column to write the data (c) and a transmission button to instruct transmission of the written data (c) to the card settlement server 1.

When receiving the data sent from the card settlement server 1 in step S207 according to the SSL protocol, the terminal C displays a basic-information transmission image represented by the data (step S109).

When the operator of the terminal C enters the data (a) or (c) in the entry column on the basic-information transmission image and further enters the data (b) in case where the domain name entered in the domain search image is a gr.jp domain and then clicks the transmission button, the terminal C sends the entered data (a) or (c) or the data (b) to the card settlement server 1 (step S110).

When receiving the data (a) or (c) or the data (b) sent from the terminal C, the card settlement server 1 accesses the user information server 3 and stores the received data (a) or (c) or the data (b) in the user information data base 31 in association with the log-in ID received in step S203 (step S208).

Next, the card settlement server 1 generates data representing a card-information transmission image (or reads the data in case where the data is prestored in a memory area in the memory unit of the card settlement server 1 itself) and sends the data to the terminal C according to the SSL protocol (step S209).

The card-information transmission image includes entry columns to write the data (d1) to (d4) and a transmission button to instruct transmission of the written data (d1) to (d4) to the card settlement server 1.

When receiving the data sent from the card settlement server 1 in step S209 according to the SSL protocol, the terminal C displays a card-information transmission image represented by the data (step S111).

When the operator of the terminal C enters card information (i.e., the data (d1) to (d4)) in the entry columns on the card-information transmission image and then clicks the transmission button, the terminal C sends the entered card information to the card settlement server 1 in accordance with the SSL protocol (step S112).

When receiving the card information sent from the terminal C, the card settlement server 1 accesses the user information server 3 and stores the card information in the user information data base 31 in association with the basic information stored in the user information data base 31 in step S208. Further, the card settlement server 1 accesses the card management server 2 and supplies the card management server 2 with the card information received from the terminal C and a command which requests the supply of information indicating the approval or denial of a credit to the user (examination result information) (step S210).

When receiving the command to request the supply of the examination result information, the card management server 2 that executes the user information data base 31 accesses the examination information data base 22 and reads examination information associated with the card information supplied in step S210. Then, the card management server 2 determines based on the read examination information whether or not to give a credit to the owner of the card that is indicated by the card information, creates examination result information representing the decision result and sends the examination result information to the card settlement server 1.

When receiving the examination result information, the card settlement server 1 determines whether

examination result information indicates crediting to the user or denial of crediting (step S211). When the card settlement server 1 decides that the examination result information indicates denial of crediting, the card settlement server 1 generates data representing an image including a message that an application for the hosting service is not acceptable, sends the data to the terminal C (step S212), then terminates the processing. In this case, the terminal C receives the data sent from the card settlement server 1 in step S212, displays an image represented by the received data, then terminates the processing.

When the card settlement server 1 decides that the examination result information indicates crediting to the user, the card settlement server 1 charges the user with an amount equivalent to the initial fee associated with the start of provision of the hosting service (step S213). Specifically, the card settlement server 1 supplies the card management server 2 with data (charge data) indicating requesting payment for an amount equivalent to the initial fee to the issuer of the credit card and the card number of the credit card which has been specified to be given a credit based on the examination result information supplied in step S211 (the card number included in the card information received in step S210) in association with each other. In this case, the card management server 2 has only to accept the charge by receiving and storing, for example, the charge data and the card number supplied from the card settlement server 1.

Next, the card settlement server 1 produces a log-in ID to be used to log in the manager Web page by the user who has applied for the hosting service and a log-in password associated with the log-in ID (step S214). Then, the card settlement server 1 stores the log-in ID and log-in password produced in step S214 in the log-in ID data base 14 in association with each other (step S215). The card settlement server 1 accesses the user information server 3 and stores the log-in ID produced in step S214 in the user information data base 31 in association with the basic information stored in the user information data base 31 in step S208.

Next, the card settlement server 1 produces data representing an image which displays the log-in ID and the log-in password produced in step S214 and sends the data to the terminal C (step S216). When receiving the data sent from the card settlement server 1 in step S216, the terminal C displays the image represented by the received data (step S113). The log-in ID and the log-in password produced by the card settlement server 1 in step S214 are located in the image displayed by the terminal C in step S113.

As the above-described procedures of steps S101 to S113 and S201 to S216 are carried out, an application for the hosting service is accepted.

The manager or the like of the hosting service providing system assigns a memory area which is to be associated with a domain name (domain name entered in the domain search image) designated by the user who applied for a hosting service to the user or applies for registration of a new domain name to an organization that manages domain names (such as JPNIC (Japan Network Information Center) or InterNIC) when the domain name designated by the user is a new one, and registers the domain name.

When the assignment of the memory area or the registration of the new domain name is completed, the manager or the like of the hosting service providing system causes the card settlement server 1 to execute the mail transmission program 12 and send an e-mail notifying the completion of the assignment of the memory area or the registration of the new domain name to the e-mail address of the applicant for the hosting service (i.e., the e-mail address indicated by the data (a15) or (c12)). The e-mail notifies the URL of the manager Web page.

After notifying the user of the completion of the assignment of the memory area or the registration of the new domain name, the manager or the like operates the card settlement server 1 and allows the card settlement server 1 to perform substantially the same process as the process of step S213 on a predetermined date, such as the date agreed with the user. Accordingly, a charge is made for the fee that is associated with the provision of the hosting service and regularly incurred.

(Procedures of Applying Dial-up Service)

The user who has applied for a hosting service and acquired a log-in ID and a log-in password manipulates the terminal C (or an external unit which is connected to the network N and executes the process of the WWW browser) to execute the process of the WWW browser and inputs the URL of the manager Web page that has been notified by an e-mail, thereby instructing an access to the card settlement server 1 (step S301 in FIG. 4).

The terminal C accesses the card settlement server 1 by performing substantially the same process as the process of step S101. (Note that the terminal C sends the URL of the manager Web page, not the URL of the domain search Web page.)

When receiving the URL of the manager Web page and the IP address of the terminal C (step S401), the card settlement server 1 generates data representing a log-in image to display the log-in image on the terminal C and sends the data to the terminal C (step S402).

The log-in image has an entry column to write the log-in ID assigned to the user, an entry column to write the log-in password associated with the log-in ID and a log-in button which instructs log-in.

When receiving data sent by the card settlement server 1, the terminal C displays a log-in image represented by the data (step S302).

When the operator of the terminal C enters a log-in ID and a log-in password in the entry columns on the log-in image and clicks the log-in button, the terminal C sends the entered log-in ID and log-in password to the card settlement server 1 (step S303).

When receiving the log-in ID and log-in password, the card settlement server 1 accesses the log-in ID data base 14 and determines whether or not the log-in ID and log-in password received from the terminal C are stored in the log-in ID data base 14 in association with each other (step S403). When the card settlement server 1 decides that the log-in ID and log-in password are not associated with each other, the card settlement server 1 sends data indicating an authentication failure to the terminal C (step S404), then terminates the processing.

When the card settlement server 1 decides that the log-in ID and log-in password are associated with each other (i.e., when authentication has succeeded), the card settlement server 1 reads data representing the manager Web page and sends the manager Web page to the terminal C (step S405). The terminal C receives the data and displays the manager Web page (step S304).

The manager Web page includes, for example, radio buttons for selecting the contents of individual pieces of data (e4) to (e9) and (e12) to (e17) included in the data (e1) to (e17) that constitute the service contents information, entry columns to write the data (e1) to (e3), (e1) and (e11), and a transmission button to instruct transmission of the result acquired by selecting a radio button and data representing the contents written in the entry columns to the card settlement server 1.

When the manager who operates the terminal C clicks a radio button on the manager Web page to select the contents of each piece of data (e4) to (e9) and (e12) to (e17), writes individual pieces of the data (e1) to (e3), (e10) and (e11) in the entry columns and clicks the transmission button, the terminal C sends the result acquired by selecting a radio button and data representing the contents written in the entry columns to the card settlement server 1 (step S305).

When receiving the data sent from the terminal C in step S305, the card settlement server 1 creates data representing an image (service approval image) which displays an agreement on provision of the service whose selection by the user is indicated by the received data and prompts an approval, and then sends the data to the terminal C (step S406). The service approval image has an approval button to notify the card settlement server 1 of an approval of the agreement.

When receiving the data sent from the card settlement server 1 in step S406, the terminal C displays the service approval image represented by the received data (step S306). When the operator clicks the approval button, the terminal C sends the card settlement server 1 a notification notifying that the user has consented the agreement displayed in step S306 (step S307).

When receiving the notification notifying that the user has consented the agreement, the card settlement server 1 accesses the user information server 3 and reads card information associated with the log-in ID received in step S403 from the user information data base 31 (step S407). Then, the card settlement server 1 accesses the card management server 2 and sends the card management server 2 the card information read from the user information data base 31 and a command to supply the examination result information (step S408).

When the card management server 2 is supplied with the command to supply the examination result information and the card information in step S408, the card management server 2 determines whether or not a credit should be given to the owner of the card indicated by the card information based on the examination result information associated with the card information, and sends the examination result information representing the decision result to the card settlement server 1.

When receiving the examination result information, the card settlement server 1 makes substantially the same decision as the one in the process of step S211 (step S409). When the card settlement server 1 decides that crediting is to be denied, the card settlement server 1 generates data representing an image including a message that an application for the service is not acceptable, sends the data to the terminal C (step S410) and then terminates the processing. In this case, the terminal C receives the data sent from the card settlement server 1 in step S409, displays the image represented by the received data, then terminates the processing.

When the card settlement server 1 decides that crediting is to be given, the card settlement server 1 generates the data (e1) to (e17) that have the contents indicated by the data received in step S406. Then, the card settlement server 1 accesses the user information server 3 and stores the generated the data (e1) to (e17) in the user information data base 31 in association with the dial-up ID received in step S403 (the aforementioned data (4)) (step S411). Those of the data (e1) to (e17) which have been stored in the user information data base 31 in association with the dial-up ID received in step S403 are overwritten and erased by the process of step S411. As a result, an application for or cancellation of the service that is indicated by those of the data (e1) to (e17) which have been altered in the process of step S411 is accepted.

Next, in case where the data received in step S406 indicates that the user has applied for a dial-up service, the card settlement server 1 invokes the dial-up service application accepting program 13. Then, the card settlement server 1 produces a dialup ID to be newly assigned to a member to whom a right to make a dial-up connection is to be given and a dial-up password to be associated with the dial-up ID (step S412). Then, the card settlement server 1 accesses the user information server 3 and stores the dial-up ID and dial-up password generated in step S214 in the dial-up ID data base 32 in association with each other (step S413).

Next, the card settlement server 1 accesses the main authentication server 4 and causes the main authentication server 4 to execute processes of steps S501 to S505 to be discussed later (step S414).

The main authentication server 4 that executes the authentication server program 41 accesses the user information server 3 in response to an instruction supplied to the main authentication server 4 in step S414. Then, the main authentication server 4 reads that of the dial-up IDs stored in the dial-up ID data base 32 which is not stored in the encryption data base 42 stored in the main authentication server 4 itself and that of the dial-up passwords stored in the dial-up ID data base 32 which is associated with that dial-up ID, and temporarily stores the dial-up ID and dial-up password (step S501).

Next, the main authentication server 4 produces an encrypted password by encrypting the dial-up password read in step S501 by a predetermined encryption scheme and stores the encrypted password and the dial-up ID associated with the dialup password that is used in generating the encrypted password in the encryption data base 42 in association with each other (step S502). Then, the main authentication server 4 erases the dial-up password which is temporarily stored in step S501 and has not been encrypted (the dial-up password in a plaintext) (step S503).

Next, the main authentication server 4 accesses the sub authentication server 5 and supplies the encrypted password produced in step S502 and the dial-up ID temporarily stored in step S501 to the sub authentication server 5 in such a way that those associated with each other in the process of step S502 are associated with each other (step S504). The sub authentication server 5 stores the dial-up ID and encrypted password supplied, associated with each other, in association with each other (step S505).

Meanwhile, based on the data received in step S406, the card settlement server 1 specifies an additional fee associated with the start of the provision of the service selected by the user indicated by the log-in ID received in step S403. Then, the card settlement server 1 creates data representing an image which displays the specified additional fee and the dial-up ID and dial-up password produced in step S412 and sends the data to the terminal C (step S415). When receiving the data sent from the card settlement server 1 in step S415, the terminal C displays the image represented by the received data (step S308).

Next, the card settlement server 1 charges an amount equivalent to the additional fee specified in step S415 (step S416). Specifically, the card settlement server 1 supplies, for example, the charge data requesting payment for an amount equivalent to the additional fee to the issuer of the credit card and the card number included in the card information read in step S407 to the card management server 2 in association with each other.

As the above-described procedures of steps S301 to S308, S401 to S416 and S501 to S505 are carried out, an application for and/or cancellation of a dial-up service or the like is accepted. A member to whom a dial-up ID and dial-up password are assigned can use the network N by operating the terminal connected to the telephone line T to establish a dial-up IP connection of the terminal to the main authentication server 4.

The structure of the hosting service providing system is not limited to the one that has been described in the foregoing description. For example, there may be a plurality of terminals C or the connection of the card settlement server 1 with the card management server 2, the user information server 3 and the main authentication server 4 or the connection between the main authentication server 4 and the sub authentication server 5 may be made by a network different from the network N or by an exclusive communications line.

Further, instead of encrypting a dial-up password supplied from an external terminal in the process (i), the main authentication server 4 that executes the functions of a dial-up server may decrypt the encrypted password associated with the dial-up ID supplied from this terminal in the process (ii) and may determine whether or not the dial-up password acquired by the decryption matches with the dial-up password supplied from the terminal.

Furthermore, the authentication server program 41 may have a capability of making always-ON connection of a terminal connected to the telephone line T to the network N (providing an always-ON connection service). In this case, the main authentication server 4 should not necessarily execute the functions of a dial-up server.

In this case, the hosting service providing system may be designed in such a way that the system accepts an application for an always-ON connection service made by the user who has receiving a hosting service, generates an always-ON connection ID and an always-ON connection password in place of the dial-up ID and dial-up password and permits always-ON connection between the terminal and the network N upon reception of the always-ON connection ID and always-ON connection password that are associated with each other.

Although the foregoing description has been given of one embodiment of the invention, the network service applying apparatus according to the invention can be achieved by using an ordinary computer system as well as an exclusive system.

For example, the hosting service providing system that executes the above-described processes can be constructed by installing a program for executing the operations of the card settlement server 1, the card management server 2, the user information server 3, the main authentication server 4 and the sub authentication server 5 into a plurality of computes each of which includes a DSU and a terminal adaptor or a modem and which are connected to one another via communications lines from a medium (CD-ROM, magnetic tap or the like) which has stored the program.

Further, the program may be placed on, for example, a bulletin board system (BBS) of a communications line and may be distributed via the communications line. Furthermore, carrier waves may be modulated with signals that represent the program, the acquired modulated waves may be transmitted and an apparatus which receives the modulated waves demodulates the modulated waves to restore the program.

The above-described processes can be carried out by invoking the program and executing them like other application programs under the control of an OS (Operating System).

In case where the OS carries out some of the processes or the OS constitutes a part of a single constituting element of the invention, a program excluding that part may be stored in a recording medium. It is assumed in this case too that the individual functions which are executed by a computer or a program which executes individual steps are stored in the recording medium according to the invention.

This application is based on Japanese Patent Application No. 2001-016346 filed on Jan. 24, 2001 and including specification, claims, drawings and summary. The disclosure of the above Japanese Patent Application is incorporated herein by reference in its entirety.

What is claimed is:

1. A network service applying apparatus comprising an accepting server and memory, wherein said accepting server:
inputs a domain name associated with a memory area accessible via a network;
inputs and stores credit information to be used for a user who is to be assigned with said memory area specified by said domain name to receive a credit;
sends out said input credit information and acquires examination result data indicating allowance or denial of a credit using said credit information sent out when receiving said examination result data;
determines whether or not a memory area to be associated with said input domain name is to be assigned to said user based on said acquired examination result data and, when having decided to assign said memory area to said user, inputs user information for specifying said user, and generates and outputs ID data for identifying said user;
stores said user information into said memory; and
when externally receiving said ID data and a notification indicating that a right to receive a network connection service is given to a third party, generates and outputs network connection ID data for identifying said right to be given to said third party by that user who is identified by said ID data, and a password associated with said network connection ID data.

2. The network service applying apparatus according to claim 1, wherein said accepting server further charges a user who is to receive a credit using said stored credit information with a consideration of assignment of said memory area to said user and a consideration of said network connection service a right for whose reception has been given to said third party by said user, by using said credit information.

3. The network service applying apparatus according to claim 1, wherein said accepting server further sends out said input domain name as one to be newly used and acquires use status report data indicating whether or not said sent domain name has already been used when receiving said use status report data; and
determines whether or not said input domain name as one to be newly used has already been used based on said acquired use status report data and stops inputting said credit information when having determined that said domain name has already been used.

4. The network service applying apparatus according to claims 1, further comprising an authentication server, wherein said authentication server:
encrypts said password generated by said accepting server and stores said password and said network connection ID data with which said password is associated in association with each other; and
when externally supplied with said network connection ID data and a password via a telephone line, determines whether or not said encrypted password associated with said network connection ID data substantially matches with said externally supplied password, and grants connection to said network via said telephone line to said third party identified by said network connection ID data when there is a match.

5. A network service applying apparatus comprising:
a domain name input section which inputs a domain name associated with a memory area accessible via a network;
a credit information input section which inputs and stores credit information to be used for a user who is to be assigned with said memory area specified by said domain name input by said domain name input section to receive a credit;
a credit examination assisting section which sends out said credit information input by said credit information input section and acquires examination result data indicating allowance or denial of a credit using said credit information sent out when receiving said examination result data;
a user information input section which determines whether or not a memory area to be associated with said domain name input by said domain name input section is to be assigned to said user based on said examination result data acquired by said credit examination assisting section and, when having decided to assign said memory area to said user, inputs user information for specifying said user, and generates and outputs ID data for identifying said user; and
a network connection service granting section which, when externally receiving said ID data and a notification indicating that a right to receive a network connection service is given to a third party, generates and outputs network connection ID data for identifying said right to be given to said third party by that user who is identified by said ID data, and a password associated with said network connection ID data.

6. A network service applying method which:
inputs a domain name associated with a memory area accessible via a network;
inputs and stores credit information to be used for a user who is to be assigned with said memory area specified by said input domain name to receive a credit;
sends out said input credit information and acquires examination result data indicating allowance or denial of a credit using said credit information sent out when receiving said examination result data;
determines whether or not a memory area to be associated with said input domain name is to be assigned to said user based on said acquired examination result data and, when having decided to assign said memory area to said user, inputs user information for specifying said user, and generates and outputs ID data for identifying said user; and
when externally receiving said ID data and a notification indicating that a right to receive a network connection service is given to a third party, generates and outputs network connection ID data for identifying said right to be given to said third party by that user who is identified by said ID data, and a password associated with said network connection ID data.

7. A computer-readable storage medium having a computer-program recorded thereon, said computer-program allowing a computer to function of:
inputting a domain name associated with a memory area accessible via a network;
inputting and storing credit information to be used for a user who is to be assigned with said memory area specified by said domain name to receive a credit;
sending out said input credit information and acquires examination result data indicating allowance or denial of a credit using said credit information sent out when receiving said examination result data;
determining whether or not a memory area to be associated with said input domain name is to be assigned to said user based on said acquired examination result data and, when having decided to assign said memory area to said user, inputs user information for specifying said user, and generates and outputs ID data for identifying said user; and
when externally receiving said ID data and a notification indicating that a right to receive a network connection service is given to a third party, generates and outputs network connection ID data for identifying said right to be given to said third party by that user who is identified by said ID data, and a password associated with said network connection ID data.

8. A computer data signal embedded in a carrier wave expressing a program for allowing a computer to function of:
inputting a domain name associated with a memory area accessible via a network;
inputting and storing credit information to be used for a user who is to be assigned with said memory area specified by said domain name to receive a credit;
sending out said input credit information and acquires examination result data indicating allowance or denial of a credit using said credit information sent out when receiving said examination result data;
determining whether or not a memory area to be associated with said input domain name is to be assigned to said user based on said acquired examination result data and, when having decided to assign said memory area to said user, inputs user information for specifying said user, and generates and outputs ID data for identifying said user; and
when externally receiving said ID data and a notification indicating that a right to receive a network connection service is given to a third party, generates and outputs network connection ID data for identifying said right to be given to said third party by that user who is identified by said ID data, and a password associated with said network connection ID data.
